(19) United States
(12) Patent Application Publication
(10) Pub. No.: US 2012/0020325 A1
(43) Pub. Date: Jan. 26, 2012

(54) METHOD AND APPARATUS FOR A HAND OFF OF A COMMUNICATION SESSION ACROSS SERVICE PROVIDER NETWORKS

(75) Inventors: Satish Nanjunda Swamy, Bangalore (IN); Sandeep Bhandari, Bangalore (IN)

(73) Assignee: MOTOROLA, INC., Schaumburg, IL (US)

(21) Appl. No.: 12/674,004

(22) PCT Filed: Aug. 28, 2008
(86) PCT No.: PCT/US08/74544

§ 371 Date: Feb. 18, 2010

(30) Foreign Application Priority Data
Sep. 20, 2007 (IN) 1997/DEL/2007

(51) Int. Cl. H04W 36/00

(52) U.S. Cl. 370/331

(57) ABSTRACT

A communication system (100) permits an inter-network handoff between networks (110, 120) operated by different network service providers, which handoff does not require that the networks interface with each other. A first user terminal (102), engaged in a wireless communication session with a second user terminal (134) via a first such network (110), detects a second such network (120). The first user terminal provides user identity information associated with the first user terminal and applicable in the second network to the second user terminal, and sets up a first leg of a communication session with the second network. The second user terminal puts the communication session with the first network on hold, sets up a communication session with the first user terminal via the second network based on the provided user identity information, and the first and second user terminals terminate the communication session with the first network.

### FIELD OF THE INVENTION

The present invention relates generally to wireless communication systems, and more specifically to handover of a communication session across networks of different wireless service providers.

### BACKGROUND OF THE INVENTION

The evolution of cellular communications has resulted in a proliferation of networks of different technologies and corresponding different air interfaces. As a result, during the course of a single call, a wireless mobile station (MS) may roam among multiple radio access networks (RANs), wherein each such RAN implements a different technology than the other RANs of the multiple RANs. For example, the MS may roam among a Wide Area Network (WAN) and a Wireless Local Area network (WLAN). Examples of the different network technologies include CDMA, GSM, CDMA 2000, UMTS, IEEE 802.11b/g, and IEEE 802.16.

In some instances, the multiple networks may be operated by a single network service provider. However, in other instances various networks of the multiple networks may be operated by different network service providers. In the latter instance, a user of the MS may subscribe to the wireless services of two or more such network service providers. For example, the user may subscribe to WAN wireless services from one network service provider and WLAN wireless services from another network service provider, or the user may subscribe to second generation (2G) wireless services from one network service provider and third generation (3G) wireless services from another network service provider, as the former may not offer the data services offered by the latter but the user is also participating in a family plan under the former. When, in the midst of an active call, the user roams into a coverage area where services are concurrently available from multiple network service providers subscribed to by the user, the user may desire to switch network service providers due to different coverage quality, different pricing structures, or different service packages subscribed to by the user and associated with each network service provider.

Currently proposed inter-network handovers assume that the networks are operated by a same network service provider or, at the very least, that the systems will have roaming agreements and can coordinate a handoff via an inter-network interface. However, that may not be the case where the systems merely co-exist and are operated independently of each other and by different network service providers. Therefore, a need exists for a method and apparatus for implementing an inter-network handoff of a communication session when the networks are operated by different network service providers, which handoff does not require that the networks interface with each other and coordinate the handoff with each other.

### BRIEF DESCRIPTION OF THE DRAWINGS

FIG. 1 is a block diagram of a wireless communication system in accordance with various embodiments of the present invention.

FIG. 2 is a block diagram of a user terminal in accordance with an embodiment of the present invention.

FIG. 3 is a block diagram of an architecture of the communication system of FIG. 1 in accordance with an embodiment of the present invention.

FIG. 4 is a signal flow diagram of a method executed by the communication system of FIG. 1 in handing off of a communication session from a first network service provider to a second network service provider in accordance with an embodiment of the present invention.

FIG. 5 is a signal flow diagram of a method executed by the communication system of FIG. 1 in handing off of a communication session from a first network service provider to a second network service provider in accordance with another embodiment of the present invention.

FIG. 6 is a signal flow diagram of a method executed by the communication system of FIG. 1 in handing off of a communication session from a first network service provider to a second network service provider in accordance with another embodiment of the present invention.

### DETAILED DESCRIPTION OF THE INVENTION

To address the need that exists for a method and apparatus that for implementing an inter-network handoff of a communication session when the networks are operated by different network service providers, which handoff does not require that the networks interface with each other and coordinate the handoff with each other, a communication system is provided that permits an inter-network handoff when the networks are operated by different network service providers, which handoff does not require that the networks interface with each other. A first user terminal that is engaged in a wireless communication session with a second user terminal via a first network, which first network is operated by a first network service provider, detects a second network that is operated by a second network service provider. The first user terminal provides user identity information associated with the first user terminal and applicable in the second network to the second user terminal, and sets up a first leg of a communication session with the second network. The second user terminal puts the communication session with the first network on hold and sets up a communication session with the first user terminal via the second network and the second network service provider based on the provided user identity information. The first and second user terminals then terminate the communication session with the first network. In another embodiment of the present invention, the communication session between the first and second user terminals via the second network may be set up without putting the communication session with the first network on hold.

Generally, an embodiment of the present invention encompasses a method for a handoff of a user terminal across wireless service provider networks. The method includes engaging in a wireless communication session with a remote end point via a first network that is operated by a first network service provider, detecting a second network that is operated by a second network service provider, and providing new user identity information associated with the user terminal and applicable in the second service provider network to the remote end point. The method further includes putting the communication session with the first network on hold, in response to putting the communication session with the first network on hold, setting up a communication session with the remote end point via the second network and the second network service provider based on the user identity information, and terminating the communication session with the first network.

Another embodiment of the present invention encompasses a method for a handoff of a user terminal across wireless service provider networks. The method includes engaging in a wireless communication session with a remote end point via a first network that is operated by a first network service provider, detecting a second network that is operated by a second network service provider, and providing user identity information applicable associated with the user terminal and applicable in the second network to the remote end point. The method further includes setting up a communication session with the remote end point via the second network and the second network service provider based on the user identity information, while maintaining the wireless communication session with the remote end point via the first network, and terminating the communication session with the first network.

Yet another embodiment of the present invention encompasses an apparatus for performing a handoff across wireless service provider networks. The apparatus includes a first user terminal and a second user terminal. The first user terminal is adapted to engage in a wireless communication session with a second user terminal via a first network that is operated by a first network service provider, detect a second network that is operated by a second network service provider, provide user identity information associated with the first user terminal and applicable in the second network to the second user terminal, and set up a first leg of a communication session with the second network. The second user terminal is adapted to put the communication session with the first network on hold and, in response to putting the communication session with the first network on hold, set up a communication session with the first user terminal via the second network and the second network service provider based on the provided user identity information. The first and second user terminals are further adapted to terminate the communication session with the first network.

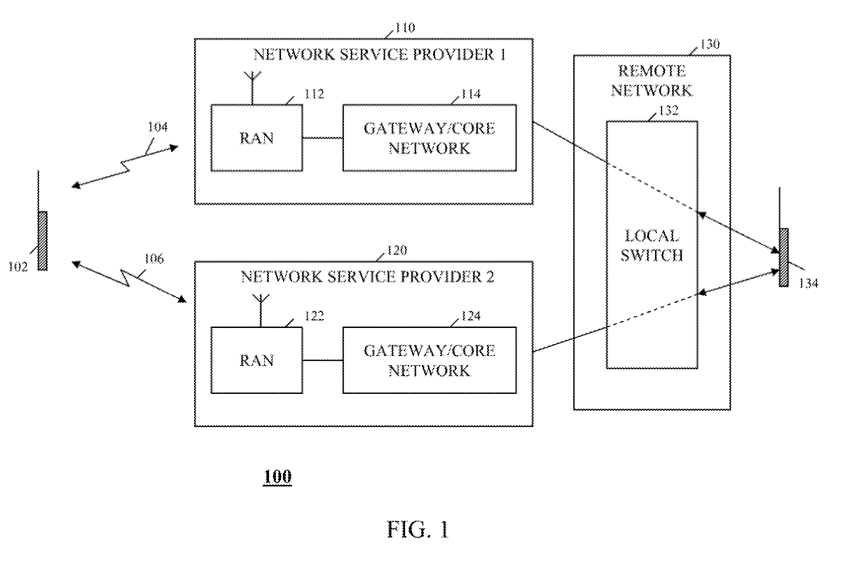

Turning now to the drawings, the present invention may be more fully described with reference to FIGS. 1-6. FIG. 1 is a block diagram of a wireless communication system 100 in accordance with various embodiments of the present invention. Communication system 100 includes multiple user terminals 102, 134. A first user terminal 102 of the multiple user terminals 102, 134 is a wireless user terminal, for example but not limited to a cellular telephone, a radiotelephone, or a Personal Digital Assistant (PDA) or laptop computer equipped for wireless voice communications. A second user terminal 134 of the multiple user terminals 102, 134 may be a wired or a wireless user terminal. User terminal 102 supports multiple subscriptions with multiple wireless network service providers that each provides wireless services via a respective wireless network 110, 120 (two shown) and is capable of engaging in a voice call with each such network.

Each of wireless networks 110, 120 includes a respective Radio Access Network (RAN) 112, 122 that is in communication with a corresponding gateway/core network 114, 124. The gateway may be one or more of a Mobile Switching Center (MSC), a Packet Data Service Node (PDSN), a Serving GPRS Support Node (SGSN), a Gateway GPRS Support Node (GGSN), a Serving Gateway (Serving GWG), a Public Data Network (PDN) Gateway, or any other element or elements known in the art that provide an interface between a RAN and a core network. For example, one or more of wireless networks 110, 120 may operate in accordance with a 2^{nd} generation (2G) wireless technology such as CDMA (Code Division Multiple Access) network or a GSM (Global System for Mobile communications) network, a 2.5 generation (2.5G) wireless technology such as a GPRS (General Packet Radio Service) network, a 3^{rd} generation (3G) wireless technology such as a 3GPP (Third Generation Partnership Project) network, a 3GPP2 (Third Generation Partnership Project 2) network, or a WiFi network based on the IEEE 802 standards, or a 4^{th} generation technology such as a 3GPP LTE (Long Term Evolution) network, a 3GPP E-UTRA (Evolved UMTS Terrestrial Radio Access) network, a 3GPP2 UMB (Ultra Mobile Broadband) network, a 3GPP2 Phase 2 network, or a WiMAX network.

Each of wireless networks 110, 120 provides wireless communication services to user terminals residing in a coverage area of the wireless network via a respective air interface 104, 106. Each air interface 104, 106 comprises a downlink and an uplink (not shown) that includes multiple communication channels, including multiple control channels and multiple traffic channels. Each of wireless networks 110, 120 is operated by a wireless network service provider. For example, a first wireless network 110 of the multiple wireless networks 110, 120 is operated by a first wireless network service provider (network service provider 1) and a second wireless network 120 of the multiple wireless networks 110, 120 is operated by a second wireless network service provider (network service provider 2) that is different from the first wireless network service provider.

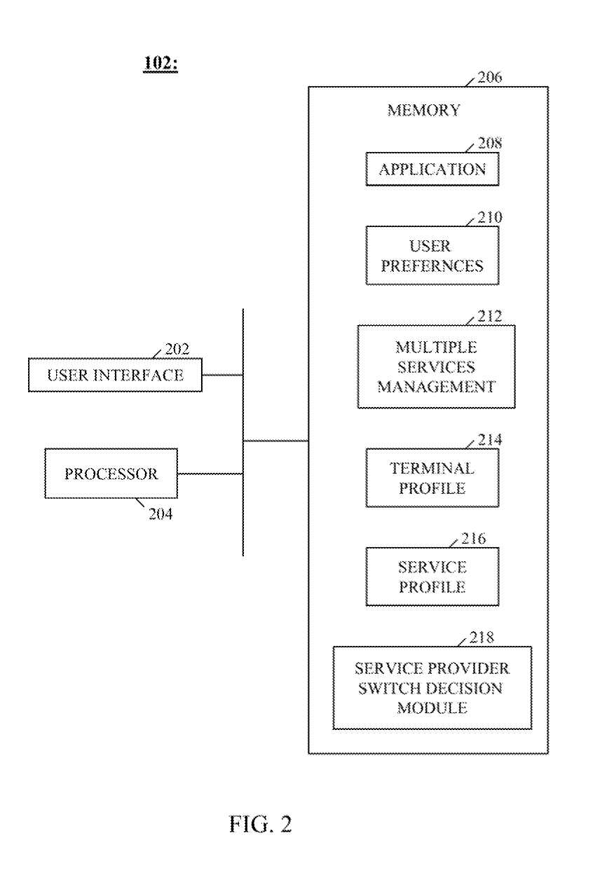

Referring now to FIG. 2, a block diagram is provided of a user terminal 200, such as user terminals 102 and 134, in accordance with an embodiment of the present invention. User terminal 200 includes a processor 204, such as one or more microprocessors, microcontrollers, digital signal processors (DSPs), combinations thereof or such other devices known to those having ordinary skill in the art, which processor is configured to execute the functions described herein as being executed by user terminal 102. The particular operations/functions of processor 204, and thus of the user terminal, is determined by an execution of software instructions and routines that are stored in an at least one memory device 206 associated with the processor, such as random access memory (RAM), dynamic random access memory (DRAM), and/or read only memory (ROM) or equivalents thereof, that store data and programs that may be executed by the corresponding processor. At least one memory device 206 includes one or more Subscriber Identity Modules (SIMs), which are described in greater detail below. User terminal 200 further includes a user interface 202 that is coupled to processor 204 and that permits a user to input instructions and information into, and receive information from, the user terminal. In various embodiments of the present invention, user interface 202 may include one or more of a display screen, which may comprise a touch screen, a keypad, audio input and output devices, visual alerts, and other components as is known in the art.

User terminal 200 further maintains, in at least one memory device 206, multiple applications 208, a user preference module 210, a multiple services management module 212, a profile 214 of the user terminal, a profile 216 of each service subscribed to by a user of the user terminal, and a service provider switch decision module 218. The multiple applications 208 includes application layer applications, such as voice applications, data applications, and control message applications including call hold and call signaling applications. User preference module 210 maintains service and operational preferences specified a user of the user terminal, such as network/network service provider preferences for call set up and handoff when multiple networks/network service providers are available, preferred call types, such as a Voice over Internet Protocol (VoIP) voice call as opposed to a circuit switched voice call. Multiple services management module 212 maintains one or more service provider preferences, if any, and any preference policy of the radio access technology or voice mode type (such as VoIP or circuit switched call) as well. Profile 214 of the user terminal maintains information such as capabilities of the user terminal, for example, radio frequency (RF) bands and air interface technologies supported by the user terminal and software versions supported by the user terminal, a mobile station identifier (mobile ID), such as an International Mobile Subscriber Identity (IMSI), associated with the user terminal, and user identity information associated with each of networks 110 and 120, such as a phone number associated with each of network service providers 1 and 2 and that may be used to access the user terminal in each of networks 110 and 120, and a RAT (radio access technology) utilized by each of networks 110 and 120. Service profile 216 maintains a listing of subscription services provided by each of network service providers 1 and 2 and subscribed to by the user/user terminal, such as call forwarding, short message service (SMS), caller identification (caller ID), and a variety of data and video services. Service provider switch decision module 218 includes logic for determining when to switch network service providers, such as thresholds used in determining when to switch network service providers, and logic for executing a switch, or handoff, of network service providers.

A first user terminal 102 of the multiple user terminals 102, 134 is a multi-mode wireless communication device that subscribes to the services of, and is capable of communicating with, each of networks 110 and 120. In one embodiment of the present invention user terminal 102 may include multiple transceivers, that is, a first transceiver for operation in network 110 and a second transceiver for operation in network 120, thereby allowing the user terminal to concurrently transmit or receive in each of the two networks. In another embodiment of the present invention, user terminal 102 may include a single transceiver and can communicate with only a single network at a time. In such an instance, user terminal may or may not be able to emulate the operation of dual transceivers by rapidly switching back and forth between two networks. The transceiver is coupled to processor 204, and the processor may cause the transceiver to rapidly switch between networks 110 and 120 to give the appearance of concurrent operation. A second user terminal 134 of the multiple user terminals 102, 134 may be a wireless communication device or a wireline communication device and may be a single mode or a multi-mode communication device, as that is not critical to the present invention.

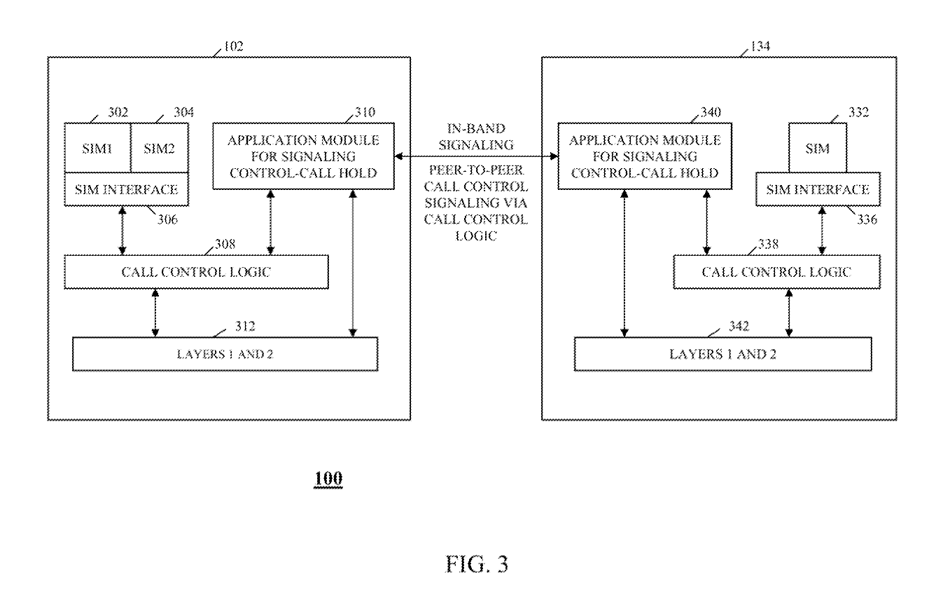

FIG. 3 is a block diagram of an architecture of communication system 100 in accordance with an embodiment of the present invention. The illustration in FIG. 3 is based on the concept of a protocol stack, in which each protocol layer uses the layer immediately below it and provides services to the layer immediate above it. The protocol stack typically includes a top, application layer. Below the application layer, in order from top to bottom, typically are a network layer, a transport layer (Layer 3), a data link layer (Layer 2) and a physical layer (Layer 1), for example, as are designated in the Open Systems Interconnect (OSI) Model as known in the art. Typically these layers, other than the physical layer and perhaps a portion of the data link layer, are implemented by processor 204 based on programs and data maintained by the at least one memory device 206.

User terminal 102 maintains network-specific upper layer data, such as Layer 3 and up, in each of multiple Subscriber Identity Modules (SIMs) 302, 304 (two shown). For example, each SIM 302, 304 may be a Subscriber Identity Module (SIM) as known in GSM, a Universal Integrated Circuit Card (UICC), or a Removable User Identity Module (RUIM), and each SIM may be included in a removable memory device or a non-removable memory device of the user terminal. Each Subscriber Identity Module (SIM) 302, 304 is associated with one of the multiple networks 110, 120 and corresponding network service providers 1 and 2 and maintains personal identity information, a phone number of the user terminal in the network, a phone book, and information that is used to authenticate and identify a user/user terminal on the network, for example, an Integrated Circuit Card Identity (ICCID), a unique International Mobile Subscriber Identity (IMSI), an Authentication Key, and a Local Area Identity (LAI). Each SIM also stores other network service provider specific data such as an SMSC (Short Message Service Center) number, a Service Provider Name (SPN), Service Dialing Numbers (SDNs), and Value Added Service (VAS) applications, and fees associated with operating on the various networks 110, 120.

At a Layer 3 level, user terminal 102 includes call control logic 308 that is included in the Call Control Layer (CC Layer). As is known in the art, the CC Layer is responsible for network signaling resource allocation in the stack. This layer is the first stage at which an incoming call may be rejected (the second stage is at the client receiving the call). The CC Layer knows about application layer signaling clients, such as application modules 310 and 340, and keeps a state of each of their connections. The CC Layer also maintains information about the calls and each client's admissible incoming call profiles (“services”). These services are passed through filters for incoming connection requests and when an incoming setup message is received, its attributes are compared against the registered services. Once a service has been found that best matches the traits of the incoming call, the client owning the service is forwarded the incoming connection request. The CC Layer also is responsible for releasing resources if the connections get terminated.

Call control logic 308 communicates with each SIM 302, 304 via a SIM interface 306 and further communicates with an application layer application module 310 that comprises programs/instructions for signaling control and performance of a call hold function. Each of call control logic 308 and application module 310 further communicate with lower layer functionality 312 that provides support for an exchange of control messages and voice and data traffic with networks 110 and 120 via respective air interfaces 104 and 106.

Similar to user terminal 102, user terminal 134 also includes a SIM 332, call control logic 338 that communicates with SIM 332 via a SIM interface 336 and with an application layer application module 340 that comprises programs/instructions for signaling control and performance of a call hold function, and lower layer functionality 342.

For purposes of the present invention, it is assumed herein that user terminal 102 initially is engaged in a voice call with first network 110. In communication system 100, while user terminal 102 is engaged in a voice call with network 110, the user terminal may roam through the system. As a result of the roaming, situations may arise where it is desirable to hand off user terminal 102 from network 110 to network 120. For example and as is known in the art, while roaming in communication system 100 and being serviced by RAN 112, user terminal 102 may receive a stronger signal from RAN 122. Typically signal strengths are determined by a user terminal, such as user terminal 102, measuring a pilot channel associated with the RAN. When a pilot channel of a serving RAN is weaker than a threshold value and a pilot channel of another RAN, that typically indicates a desirability of a handoff.

By way of another example, the costs associated with operating user terminal 102 on network 110 may be different from the costs associated with operating user terminal 102 on network 120. In turn, network service providers 1 and 2 may charge a different fee for use of their corresponding networks 110, 120. As a result, a user of user terminal 102 may program into the subscriber a directive to operate on the lower cost network whenever the user terminal is able to obtain a traffic channel in the lower cost network. When user terminal 102 is engaged in a voice call in a higher cost network and is able to obtain a traffic channel in the lower cost network, the user terminal, or the user of the user terminal if the user is informed of the availability of a traffic channel in the lower cost network, may initiate a handoff to the lower cost network. By way of yet another example, it may be desirable to move a user terminal, such as user terminal 102, that is actively engaged in a voice call in network 110 to network 120 when the user of user terminal 102 prefers to use a later generation service, such as a video telephony service, available from network 120 rather than a voice call service that the user terminal is currently utilizing in network 110, and network 120 supports video telephony but network 110 does not. By way of still another example, due to perceived network congestion, a user of user terminal 102 may desire to move from network 110 to the other network.

In order to facilitate a handoff of a user terminal, such as user terminal 102, communication system 100 provides a method and apparatus for an active handoff of the user terminal from the first network service provider, that is, network service provider 1, and corresponding first network 110, to the second network service provider, that is, network service provider 2, and corresponding second network 120, while the user terminal is actively engaged in a voice call in the first network. By providing for a handoff of a voice call from network service provider 1 and network 110 to network service provider 2 and network 120, communication system 100 assures that the user terminal is actively engaged in a communication session with at least one of networks 110 and 120 at nearly all times and is able to operate on a preferred network when the preferred network is available.

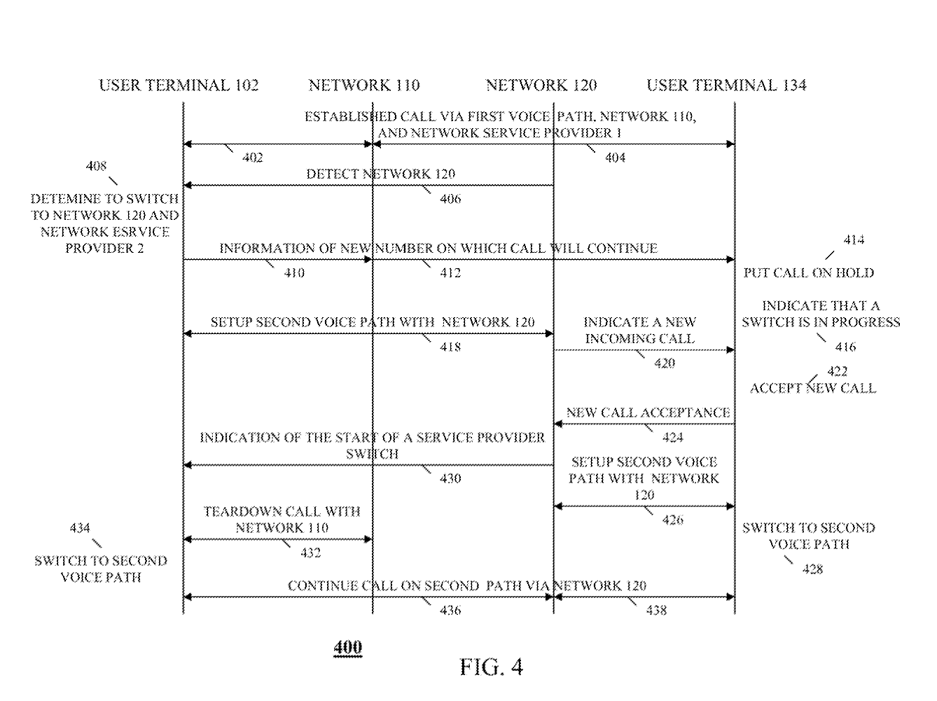

Referring now to FIG. 4, a signal flow diagram 400 is provided that illustrates a method executed by communication system 100 in handing off user terminal 102 from network service provider 1 and network 110 to network service provider 2 and network 120 in accordance with an embodiment of the present invention. In the embodiment depicted by FIG. 4, user terminal 102 transmits only to a single network at any given time. Signal flow diagram 400 begins when user terminal 102 is engaged in a communication session, and in particular a voice call, via a first voice path (402, 404) with a remote end point, that is, user terminal 134, via a first network, that is, network 110, and a first network service provider, that is, network service provider 1, and via a remote network 130 that includes a local switch 132, such as a local switching office in the case of a wireline system or a local gateway, such as an MSC, in the case of a wireless system.

While user terminal 102 is actively engaged in a voice call with network 110, the user terminal detects (406) a second network, that is, network 120, associated with a second network service provider, that is, network service provider 2, different from the first network service provider. For example, user terminal 102 may detect a pilot associated with RAN 122 of network 120. The user terminal then monitors qualities, in particular a signal strength or alternatively any of a variety of other signal qualities such as a signal-to-noise ratio (SNR), a carrier-to-interference ratio (C/I), pilot power-to-total power (Ec/Io) ratio, a bit error rate (BER), or a frame error rate (FER), of pilots associated with each of RAN 112 of network 110 and RAN 122 of network 120. User terminal 102 may monitor the pilots of each network 110, 120 concurrently or may switch between networks in monitoring the pilots.

Based on the monitored pilots, user terminal 102, with reference to one or more of user preferences module 210, service profile 216, and service provider switch decision module 218 of the user terminal, then determines (408) to handoff from RAN 112, network 110, and network service provider 1 to RAN 122, network 120, and network service provider 2. For example, when a pilot of RAN 112 compares unfavorably to (is below, in the case of a signal strength threshold) an intra-system handoff threshold and/or a pilot of RAN 122 compares favorably to (exceeds, in the case of a signal strength threshold) an inter-system handoff threshold, this may indicate a desirability of a handoff. By way of another example, costs associated with operating user terminal 102 on network 110 may be different from the costs associated with operating user terminal 102 on network 120. In turn, network service providers 1 and 2 may charge a different fee for use of each network. If network 120 is the lower cost network, a user of user terminal 102 may program into the MS a directive to operate on network 120 whenever a measurement of a pilot associated with the second network compares favorably to the inter-system handoff threshold. By way of yet another example, user terminal may prefer network 120 due to a service or services that the user terminal subscribes to from network 120 and not from network 110. By way of still another example, due to network congestion or a need to clear traffic channels in a coverage area in order to facilitate emergency communications, an operator of user terminal 102 may find it desirable to move the user terminal, when actively engaged in a voice call in network 110, to network 120.

In response to determining to handoff user terminal 102 from network 110 and RAN 112 to network 120 and RAN 122, user terminal 102 conveys (410, 412), to user terminal 134 via network 110, user identity information, such as the new phone number from service provider 2 that may be used to access user terminal 102 in network 120 and the RAT (radio access technology) from which the new call will be made, for user terminal 102 in network 120. Referring now to FIGS. 2 and 3, in providing the new user identity information, processor 204 of user terminal 102, application module for signaling control and call hold 310 retrieves the user identity information from the SIM 302, 304 corresponding to network 120 and directs call control logic 308 to route this information to user terminal 134. Processor 204, and more particularly call control logic 308, then conveys the user identity information to call control logic 338 of user terminal 134 via in-band, peer-to-peer Layer 3 call control signaling that utilizes the first voice path established between user terminals 102 and 134 via network 110. For example, the signaling may be by use of a string of DTMF tones, may be included in a payload of an in-band data packet that may include a flag indicating that the data packet includes signaling data, or may be included in a header extension of an in-band data packet. In response to receiving the user identity information for user terminal 102, call control logic 338 of user terminal 134 routes this information to application module for signaling control and call hold 340, which stores the received user identity information in at least one memory device 206 of user terminal 134.

Referring again to FIG. 4, in response to receiving the user identity information for user terminal 102 in network 120, user terminal 134 puts (414) the call with user terminal 102 via network 110 on call hold, thereby freeing up signaling resources and allowing user terminal 134 to receive a call from network 120. As described below, network 120 then contacts user 134 after the user terminal 102 has established a new voice path with network 120 in order to reach user terminal 134. User terminal 134 further indicates (416), to a user of user terminal 134, that a network switch is in progress. For example, user terminal 134 may indicate the call switch by playing an audio tone via user interface 202 of the user terminal or may display a textual message in the user interface. Further, in response to determining to switch to network 120 and network service provider 2, user terminal 102 sets up (418) a first leg (between user terminal 102 and network 120) of a second traffic channel (voice path) with network 120 via RAN 122 in accordance with well known techniques. In setting up the first leg of the second voice path, user terminal 102 provides second network 120 with routing information for user terminal 134, such as a routing identifier such as a destination identifier or a phone number, that allows network 120 to locate and contact user terminal 134. Further, in setting up the call, user terminal 102 and network 120 set up a second voice path, which includes assigning resources to user terminal 102 at RAN 122, such as downlink and uplink traffic channels in air interface 106, and providing routing for the call in gateway/core network 124.

In response to the successful assignment of channels and establishment of a call with user terminal 102, network 120 conveys (420) a call set up signaling message to user terminal 134 indicating that the user terminal has a new incoming call from user terminal 102, which signaling message identifies network 120 as sourcing the message. In response to being informed of a new call from user terminal 102 via network 120, user terminal 134 accepts (422) the new call and conveys (424) an acceptance of the new call back to network 120. Further, in response to being informed of the new call from user terminal 102 via network 120 and accepting the new call, user terminal 134 establishes (426) a second leg (between user terminal 134 and network 120) of the second voice path with network 120. User terminal 134 switches (428) over to the second voice path and hangs up on, that is, terminates, its connection to the first voice path.

In one embodiment of the invention, user terminal 134 may automatically accept the new call and convey the acceptance to network 120. In another embodiment of the present invention, in response to receiving the message informing of a new incoming call from user terminal 102, user terminal 134 may notify the user of the terminal of the new call, for example, via an audio tone or a textual message played or displayed via user interface 202 of the user terminal. Responsive to the notification of the new call, user terminal 134 receives an instruction from the user to accept the call and then conveys the acceptance of the new call to network 120.

In response to receiving the new call acceptance, network 120 notifies (430) user terminal 102, via network 110 and in-band signaling, that user terminal 134 has accepted the new call over network 120 and that user terminal 102 may proceed with switching the call to network 120. In response to being notified that it may proceed to switch to network 120, user terminal 102 initiates (432) a termination of the call with user terminal 134 via network 110, which call has been put on hold. More particularly, in response to being notified that it may proceed to switch to network 120, user terminal 102 requests that network 110 release the resources allocated by the network to the user terminal, for example, by conveying a release message to network 110 via RAN 112. In response to receiving the request to release resources, network 110 tears down the first voice path; more specifically, RAN 112 releases resources allocated at the RAN to user terminal 102 for the voice call and gateway/core network 114 releases resources allocated to the call and user terminal 102 in network 110. The call via network 110 then is terminated. In addition, in response to being notified that it may proceed to switch to network 120, user terminal 102 switches (434) to the second voice path, that is, begins exchanging voice and/or data, and signaling, with user terminal 134 via the communication path established with RAN 122 and network 120. The call between user terminal 102 and user terminal 134 now proceeds (436, 438) via the second voice path and network 120. Signal flow diagram 400 then ends.

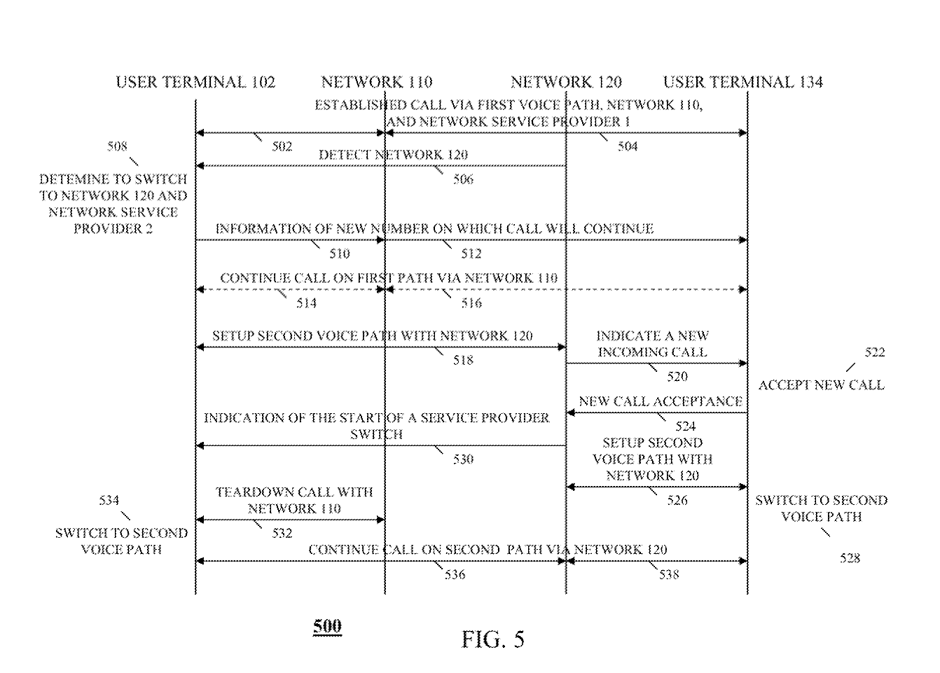

Referring now to FIG. 5, a signal flow diagram 500 is provided that illustrates a method executed by communication system 100 in handing off user terminal 102 from network service provider 1 and network 110 to network service provider 2 and network 120 in accordance with another embodiment of the present invention. In the embodiment depicted by FIG. 5, user terminal 102 concurrently transmits to both networks 110 and 120. Signal flow diagram 500 begins when user terminal 102 is engaged in a communication session, and in particular a voice call, via a first voice path (502, 504) with a remote end point, that is, user terminal 134, via a first network, that is, network 110, and a first network service provider, that is, network service provider 1, via a remote network 130, including a local switch 132.

While user terminal 102 is actively engaged in a voice call with network 110, the user terminal detects (506) a second network, that is, network 120, associated with a second network service provider, that is, network service provider 2, different from the first network service provider. In response to detecting network 120, user terminal 102 then determines (508) to handoff from RAN 112, network 110, and network service provider 1 to RAN 122, network 120, and network service provider 2. Methods of detecting, and determining to handoff to, network 120 are described above in greater detail and will not be repeated here.

In response to determining to handoff user terminal 102 from network 110 and RAN 112 to network 120 and RAN 122, user terminal 102 conveys (510, 512), to user terminal 134 via network 110, user identity information for user terminal 102 in network 120, such as the new phone number from service provider 2 that may be used to access user terminal 102 in network 120 and the RAT from which the new call will be made. As described above with respect to signal flow diagram 400, the user identity information is retrieved from a SIM 302, 304 of user terminal 102 and is conveyed via in-band peer-to-peer Layer 3 control signaling. However, as opposed to signal flow diagram, since user terminal 102 is able to concurrently transmit to both networks 110 and 120, the call between user terminal 102 and user terminal 134 via network 110 is not put on call hold but, instead, actively continues (514, 516) via network 110 while a second voice path is being set up between user terminal 102 and network 120.

In response to determining to switch to network 120 and network service provider 2, user terminal 102 sets up (518) a first leg (between user terminal 102 and network 120) of a second voice path with network 120 and via RAN 122 in accordance with well known techniques. In setting up the first leg of the second voice path, user terminal 102 provides second network 120 with routing information for user terminal 134, such as a routing identifier such as a destination identifier or a phone number, that allows network 120 to locate and contact user terminal 134. Further, in setting up the call, user terminal 102 and network 120 set up a second voice path, which includes assigning resources to user terminal 102 at RAN 122, such as downlink and uplink traffic channels in air interface 106, and providing routing for the call in gateway/core network 124.

In response to the successful assignment of channels and establishment of a call with user terminal 102, network 120 conveys (520) a message to user terminal 134 informing that the user terminal has a new incoming call from user terminal 102. Preferably, the call from network 110 is on hold as user terminal 134 receives the new call from the user terminal 102. In response to being informed of a new call from user terminal 102 via network 120, user terminal 134 accepts (522) the new call and conveys (524) an acceptance of the new call to network 120. Further, in response to being informed of the new call from user terminal 102 via network 120 and accepting the new call, user terminal 134 establishes (526) a second leg (between user terminal 134 and network 120) of the second voice path with network 120. User terminal 134 switches over (528) to the second voice path and hangs up on, that is, terminates, its connection to the first voice path.

In one embodiment of the invention, user terminal 134 may automatically accept the new call and convey the acceptance to network 120. In another embodiment of the present invention, in response to receiving the message informing of a new incoming call from user terminal 102, user terminal 134 may notify the user of the terminal of the new call. In response to the notification, user terminal 134 receives an instruction from the user to accept the call and then conveys the acceptance of the new call to network 120.

In response to receiving the new call acceptance, network 120 notifies (530) user terminal 102 that user terminal 134 has accepted the new call via network 120 and that user terminal 102 may proceed with switching the call to network 120. In response to being notified that it may proceed to switch to network 120, user terminal 102 initiates (532) a termination of the call with user terminal 134 that network 110 has continued to support and maintain until such termination. More particularly, in response to being notified that it may proceed to switch to network 120, the user terminal 102 requests that network 110 release the resources allocated by the network to the user terminal, for example, by conveying a release message to network 110 via RAN 112. In response to receiving the request to release resources, network 110 proceeds to tear down the first voice path as described above in greater detail. In addition, in response to being notified that it may proceed to switch to network 120, user terminal 102 switches (534) to the second voice path, that is, begins exchanging voice and/or data, and signaling, with user terminal 134 via the communication path established with RAN 122 and network 120. The call between user terminal 102 and user terminal 134 now proceeds (536, 538) via the second voice path and network 120, and signal flow diagram 500 then ends.

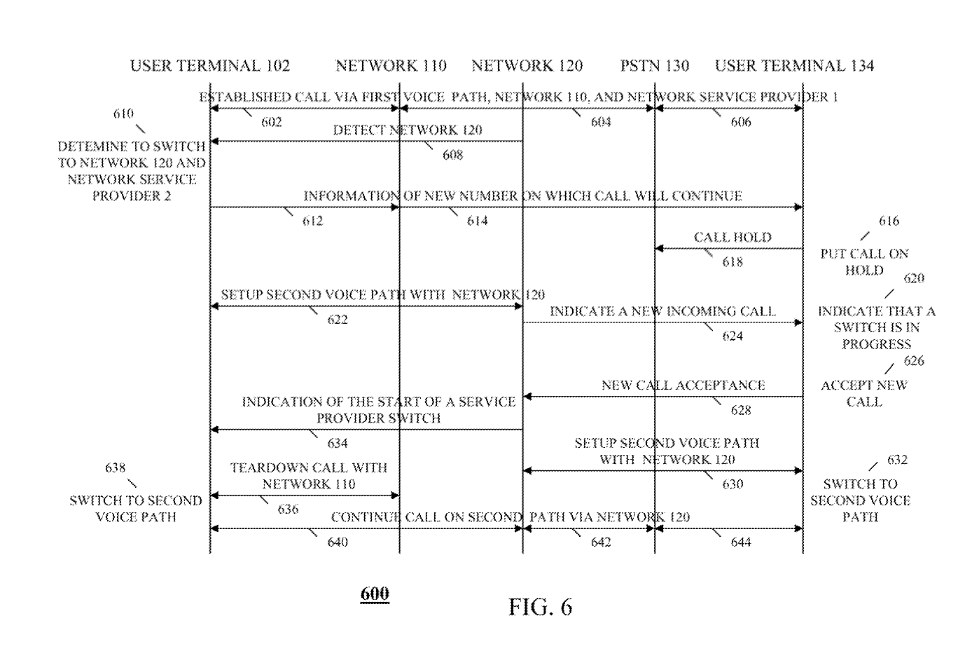

Referring now to FIG. 6, a signal flow diagram 600 is provided that illustrates a method executed by communication system 100 in handing off user terminal 102 from network service provider 1 and network 110 to network service provider 2 and network 120 in accordance with yet another embodiment of the present invention. In the embodiment depicted by FIG. 6, it is assumed that user terminal 134 is a wireline user terminal. Signal flow diagram 600 begins when user terminal 102 is engaged in a communication session, and in particular a voice call, via a first voice path (602, 604, 606) with a remote end point, that is, user terminal 134, via a first network, that is, network 110, and a first network service provider, that is, network service provider 1, and a wireline network 130, such as a Public Switched Telephone Network (PSTN), and a local switching office 132.

While user terminal 102 is actively engaged in a voice call with network 110, the user terminal detects (608) a second network, that is, network 120, associated with a second network service provider, that is, network service provider 2, different from the first network service provider. In response to detecting network 120, user terminal 102 then determines (610) to handoff from RAN 112, network 110, and network service provider 1 to RAN 122, network 120, and network service provider 2. Methods of detecting, and determining to handoff to, network 120 are described above in greater detail and will not be repeated here.

In response to determining to switch from network 110 and RAN 112 to network 120 and RAN 122, user terminal 102 conveys (612, 614), to user terminal 134 via network 110, user identity information for user terminal 102 in network 120, such as the new phone number from service provider 2 that may be used to access user terminal 102 in network 120 and the RAT from which the new call will be made. As described above with respect to signal flow diagram 400, the user identity information is retrieved from a SIM 302, 304 of user terminal 102 and is conveyed via in-band peer-to-peer Layer 3 control signaling. In response to receiving the user identity information for user terminal 102 in network 120, user terminal 134 determines (616) to put the call with user terminal 102 via network 110 on call hold and instructs (618) wireline network 130 to put the call on call hold, thereby freeing up signaling resources in order to receive a call from network 120. In addition, user terminal 134 indicates (620), to a user of user terminal 134, that a network switch is in progress. For example, user terminal 134 may indicate the call switch by playing an audio tone via user interface 202 of the user terminal or may display a text message in the user interface.

Further in response to determining to switch to network 120 and network service provider 2, user terminal 102 sets up (622) a first leg (between user terminal 102 and network 120) of a second voice path with network 120 via RAN 122 in accordance with well known techniques. In setting up the first leg of the second voice path, user terminal 102 provides second network 120 with routing information for user terminal 134, such as a routing identifier such as a destination identifier or a phone number, that allows network 120 to locate and contact user terminal 134. Further, in setting up the call, user terminal 102 and network 120 set up a second voice path, which includes assigning resources to user terminal 102 at RAN 122, such as downlink and uplink traffic channels in air interface 106, and providing routing for the call in gateway/core network 124.

In response to the successful assignment of channels and establishment of a call with user terminal 102, network 120 conveys (624) a call set up signaling message to user terminal 134 indicating that the user terminal has a new incoming call from user terminal 102, which signaling message identifies network 120 as sourcing the message. In response to being informed of a new call from user terminal 102 via network 120, user terminal 134 accepts (626) the new call and conveys (628) an acceptance of the new call to network 120. Further, in response to being informed of the new call from user terminal 102 via network 120 and accepting the new call, user terminal 134 establishes (630) a second leg (between user terminal 134 and network 120) of the second voice path with network 120. User terminal 134 switches over (632) to the second voice path and hangs up on, that is, terminates, its connection to the first voice path.

In one embodiment of the invention, user terminal 134 may automatically accept the new call and convey the acceptance to network 120. In another embodiment of the present invention, in response to receiving the message informing of a new incoming call from user terminal 102, user terminal 134 may notify the user of the terminal of the new call. In response to the notification, user terminal 134 receives an instruction from the user to accept the call and then conveys the acceptance of the new call to network 120.

In response to receiving the new call acceptance, network 120 notifies (634) user terminal 102 that user terminal 134 has accepted the new call via network 120 and that user terminal 102 may proceed with switching the call to network 120. In response to being notified that it may proceed to switch to network 120, user terminal 102 initiates (636) a termination of the call with user terminal 134 via network 110 that has been put on hold. More particularly, in response to being notified that it may proceed to switch to network 120, the user terminal 102 requests that network 110 release the resources allocated by the network to the user terminal, for example, by conveying a release message to network 110 via RAN 112. In response to receiving the request to release resources, network 110 proceeds to tear down the first voice path as described above in greater detail. The call via network 110 then is terminated. In addition, in response to being notified that it may proceed to switch to network 120, user terminal 102 switches (638) to the second voice path, that is, begins exchanging voice and/or data, and signaling, with user terminal 134 via the communication path established with RAN 122 and network 120. The call between user terminal 102 and user terminal 134 now proceeds (640, 642, 644) via the second voice path and network 120, and signal flow diagram 600 then ends.

By the first user terminal 104 providing, via first network 110, user identity information associated with the first user terminal and applicable in the second network 120 to the second user terminal 134, communication system 100 permits an inter-network handoff between the networks that are operated by different network service providers, which handoff does not require that the networks interface with each other. In one embodiment of the present invention, user terminal 102, when engaged in a wireless communication session with user terminal 134 via network 110, which network is operated by network service provider 1, detects network 120, which network that is operated by network service provider 2. User terminal 102 provides user identity information associated with user terminal 102 and applicable in the second network 120 to user terminal 134, and sets up a first leg of a communication session with network 120. User terminal 134 puts the communication session with network 110 on hold and sets up a communication session with user terminal 102 via network 120 and network service provider 2 based on the provided user identity information. User terminals 102 and 134 then terminate the communication session with first network 110. In another embodiment of the present invention, the communication session between user terminals 102 and 134 via network 120 may be set up without putting the communication session with network 110 on hold.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. The terms ‘including’ and/or ‘having,’ as used herein, are defined as comprising. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions. An element preceded by “ . . . a” does not, without more constraints, preclude the existence of additional identical elements in the process, method, article, or apparatus that the element.

What is claimed is:

1. A method for a handoff of a user terminal across wireless service provider networks, the method comprising:
engaging in a wireless communication session with a remote end point via a first network that is operated by a first network service provider;
detecting a second network that is operated by a second network service provider;
providing user identity information associated with the user terminal and applicable in the second service provider network to the remote end point;
putting the communication session with the first network on hold;
in response to putting the communication session with the first network on hold, setting up a communication session with the remote end point via the second network and the second network service provider based on the user identity information; and
terminating the communication session with the first network.

2. The method of claim 1, wherein providing user identity information as applicable in the second service provider network comprises conveying user identity information to the remote end point via in-band signaling.

3. The method of claim 1, wherein the wireless communication session via the first network comprises a voice path and wherein providing user identity information comprises conveying user identity information to the remote end point via the voice path.

4. The method of claim 1, wherein providing user identity information comprises conveying user identity information to the remote end point via Layer 3 call control signaling.

5. A method for a handoff of a user terminal across wireless service provider networks, the method comprising:
engaging in a wireless communication session with a remote end point via a first network that is operated by a first network service provider;
detecting a second network that is operated by a second network service provider;
providing user identity information applicable associated with the user terminal and applicable in the second network to the remote end point;
setting up a communication session with the remote end point via the second network and the second network service provider based on the user identity information, while maintaining the wireless communication session with the remote end point via the first network; and
terminating the communication session with the first network.

6. The method of claim 5, wherein providing user identity information comprises conveying user identity information to the remote end point via in-band signaling.

7. The method of claim 5, wherein the wireless communication session via the first network comprises a voice path and wherein providing user identity information comprises conveying user identity information to the remote end point via the voice path.

8. The method of claim 5, wherein providing user identity information comprises conveying user identity information to the remote end point via Layer 3 call control signaling.

9. An apparatus for performing a handoff across wireless service provider networks, the apparatus comprising:
a first user terminal that is adapted to engage in a wireless communication session with a second user terminal via a first network that is operated by a first network service provider, detect a second network that is operated by a second network service provider, provide user identity information associated with the first user terminal and applicable in the second network to the second user terminal, and set up a first leg of a communication session with the second network;
the second user terminal, which second user terminal is adapted to put the communication session with the first network on hold and, in response to putting the communication session with the first network on hold, set up a communication session with the first user terminal via the second network and the second network service provider based on the provided user identity information; and
wherein the first and second user terminals are further adapted to terminate the communication session with the first network.

10. The apparatus of claim 9, wherein the first user terminal provides user identity information by conveying the user identity information to the second user terminal via in-band signaling.

11. The apparatus of claim 9, wherein the wireless communication session via the first network comprises a voice path and wherein the first user terminal provides user identity information by conveying the user identity information to the second user terminal via the voice path.

12. The apparatus of claim 9, wherein the first user terminal provides user identity information by conveying the user identity information to the second user terminal via Layer 3 call control signaling.
